(19) United States
(12) Patent Application Publication
(10) Pub. No.: US 2023/0415409 A1
(43) Pub. Date: Dec. 28, 2023

(54) ENHANCED FEEDSTOCK FOR ADDITIVE MANUFACTURING

(71) Applicants: UCL Business Ltd., London (GB); Imperial College Innovations Limited, London (GB)

(72) Inventors: Chu Lun Alex Leung, London (GB); Iuliia Elizarova, London (GB); Peter D Lee, London (GB); Eduardo Saiz, London (GB)

(21) Appl. No.: 18/249,495

(22) PCT Filed: Oct. 20, 2021
(86) PCT No.: PCT/GB2021/052704

§ 371 Date: Apr. 18, 2023

(30) Foreign Application Priority Data
Oct. 20, 2020 (GB) 2016624.5

(51) Int. Cl. B29C 64/165; C01B 32/194; B29C 64/314; B33Y 70/10

(52) U.S. Cl. CPC B29C 64/165; C01B 32/194; B29C 64/314; B33Y 70/10

(57) ABSTRACT

A method for producing an additive manufacturing feedstock, the method comprising adding a photothermal agent to a construction material to cause the photothermal agent to be in thermally conductive contact with the construction material, whereby to produce the additive manufacturing feedstock, wherein the photothermal agent comprises chemically modified graphene, CMG.

### TECHNOLOGICAL BACKGROUND

Additive manufacturing (AM) is a manufacturing technology that fabricates components with high complexity, layer-by-layer, from a digital file. Typically, an additive manufacturing apparatus is fed with a feedstock for processing into a component.

However, there are limited choices of commercial feedstocks for AM. For example, in cases where AM is carried out using a laser or other incident electromagnetic (EM) radiation, it is important to select a construction material which couples well with the EM radiation being used. By ‘coupling’, it is meant that the construction material absorbs the EM radiation and then induces a photothermal effect, in which a portion of the photon energy is transferred into the construction material in the form of heat. This process is used to fuse portions of the construction material together, thereby forming a component.

Some approaches to additive manufacturing use pre- or post-treatments of manufactured components in order to enhance the material properties of said components. For example, one type of AM that uses EM radiation is laser powder bed fusion (LPBF), wherein a layer of powdered feedstock is laid onto a bed of an AM apparatus. A laser is then used to sinter elements of the powder together into a pre-formed component. The term ‘sinter’ is used to distinguish from ‘melt’ as in this approach the particles of the powder are typically not fully melted; only outer surfaces of particles are melted and bound together.

In order to improve material properties of manufactured components, for example pre-formed/sintered components, it is common to heat treat the components. This may for example be performed in an oven or furnace. This reduces the porosity of the components, having gaps between neighbouring sintered particles due to a sub-optimal tessellation of particles in the powder bed. To achieve desired dimensions, it is common to scale-up the dimensions of components during the design phase in order to take into consideration the shrinkage of the components after post-treatment.

As a further issue, LPBF and other layer-by-layer AM techniques often face problems when overhangs exist in components. That is, sintered powders typically do not bear the structural integrity to withstand the force moments incurred by overhanging portions of components.

Whilst the above-described issues can be somewhat addressed, these approaches can be complex and are limited in the choice of potential feedstock. In particular, a given AM system may need to be specifically (and inflexibly) configured to work with a specific feedstock. There is therefore a desire for additive manufacturing techniques with reduced operational complexity and/or with the capacity to more rapidly produce higher-quality components. There is also a desire for additive manufacturing technologies which allow a given system to operate with a wider range of feedstocks.

### SUMMARY

Viewed from a first aspect, the present invention relates to a method for producing an additive manufacturing feedstock. The method includes adding a photothermal agent to a construction material to cause the photothermal agent to be in thermally conductive contact with the construction material, whereby to produce the additive manufacturing feedstock. A photothermal agent is any substance, compound, additive or the like that has enhanced photothermal properties. That is, when EM radiation is incident upon a photothermal agent, the photothermal agent readily converts photon energy from the EM radiation into thermal energy.

The photothermal agent advantageously comprises chemically modified graphene (CMG). By employing CMG as a photothermal agent, the absorptivity of construction materials can be greatly increased relative to comparative examples that do not use a photothermal agent or use photothermal agents that do not comprise CMG. In some examples, CMG comprises reduced graphene oxide, RGO. However, CMG can also be any graphene fabricated by any means (e.g. exfoliation of graphite using solvents) whose surface chemistry has been manipulated to at least some degree.

As a result, it becomes possible to employ AM techniques for manufacturing components out of a wide range of construction materials. For example, construction materials that have a high reflectivity are typically not well-suited to laser-based AM techniques that use EM radiation, as the EM radiation is reflected off of the construction material as opposed to being absorbed and, thus, the material does not heat up and cannot be fused. However, by adding a photothermal agent comprising CMG, the photothermal agent can absorb photons on behalf of the construction material, convert their energy into heat, and then transfer said heat into the construction material by virtue of being in thermally conductive contact therewith.

As described in more detail below, the chemical properties of CMG make it especially effective as a photothermal agent. Therefore, relative to comparative examples that use photothermal agents that do not comprise CMG, less photothermal agent needs to be added to a construction material to achieve the enhanced photothermal effects. Therefore, there is less risk that the photothermal agent substantially persists in the manufactured component, having been mostly vaporised, and less risk of creating defects when the photothermal agent evaporates during processing.

CMG also demonstrates improved photothermal properties for a wider range of EM radiation wavelengths than comparative examples that do not contain CMG. Therefore, AM apparatuses that employ different EM radiation sources (e.g. lasers of differing wavelengths) can still be used to manufacture components from construction materials with otherwise high reflectivities (and thus low absorptivities). For example, the present techniques can extend the uses of existing near-infra-red (near-IR) AM machines for processing metals with low photon absorbance, e.g. Cu, Al, Au, Ag, and the like, as well as refractory polymers, glasses, and ceramics (e.g. silica-based materials). Therefore, the use of a photothermal agent that comprises CMG widens the palette of materials possible to process by a given AM system.

CMG also has superior thermal conduction properties. Therefore, the thermal energy produced in the photothermal agent, comprising CMG, is more readily transferred into the construction material, and between different portions of the AM feedstock, than for comparative examples. For example, it has been realised by the present inventors that CMG increases the photon absorptivity and thermal conductivity of AM feedstocks by approximately 5 times and approximately 30 times better, respectively, than that achieved by a non-CMG carbon additive such as carbon black. Good thermal conductivity across an AM feedstock improves the precision and quality of parts additively manufactured using said AM feedstocks.

In a comparative example in which ceramic feedstock is used, a binder or adhesive may be used to increase the sinterability of ceramic particles. In the particular example of ceramic AM, the present approach does not require the addition of a binder to the feedstock mixtures. An advantage is thus that the lengthy and size-limiting de-binding stage of production, commonly associated with the production of ceramic parts, is eliminated, in both traditional and AM routes. Additionally, the density of the manufactured components is enhanced. To demonstrate this with a particular example, comparative indirect sintering processes for ceramic materials require up to 60% by volume of binder. However, in some examples the presently disclosed photothermal agent can allow effective AM when introduced at an amount equivalent to as little as 0.01-0.5% by weight, thus allowing the production of a product with a high concentration of ceramic construction material and a consequently high build quality.

The present invention may benefit from any number of the following example refinements.

The photothermal agent may be added to the construction material in a number of different ways. In one example, the above described method of manufacturing the AM feedstock further comprises mechanically mixing the construction material with the photothermal agent. Alternatively, adding the photothermal agent to the construction material may comprise adding a chemical precursor of the CMG to the construction material, so as to create a mixture. In this example, the method further comprises chemically treating the mixture, whereby to produce the AM feedstock. By mechanically mixing the construction material with the photothermal agent or a chemical precursor thereto (for later chemical treatment), the photothermal agent can be well distributed throughout/around the construction material, for example becoming embedded in the surface of the construction material or being chemically bound. This approach is efficiently scalable as mechanical mixers can process materials at quantities in the order of tonnes or more.

In an example in which the CMG comprises RGO, the chemical precursor of the CMG comprises graphene oxide, GO. In this example, one option for chemically treating the mixture comprises heating the mixture to chemically reduce the GO to RGO. The techniques for manufacturing GO are such that GO can be readily attained at low cost and the transport and/or storage of GO is relatively straightforward as it is chemically stable. It is common for GO to be sold in the form of flakes, powders, or dispersions. Once the GO has been added to the construction material, for example by mechanical mixing, a chemical treatment can be applied to convert the GO into RGO, i.e. reducing it. Heating the mixture is another scalable process, as furnaces or ovens can take almost any size and thus process materials rapidly or in large batches.

Viewed from a second aspect, the present invention relates to an additive manufacturing feedstock. The additive manufacturing feedstock comprises a construction material and a photothermal agent to convert at least a part of incident light into thermal energy, as discussed above. Advantageously, the photothermal agent is in thermally conductive contact with the construction material so that thermal energy, arising as a result of the photothermal effect, can be communicated from the photothermal agent to the construction material. The photothermal agent comprises chemically modified graphene, CMG, which provides superior photothermal properties, described in more detail above and in the following description. As mentioned above, in some examples, the CMG comprises RGO.

The AM feedstock may take a variety of forms. In some examples, the additive manufacturing feedstock has a form factor of one of a powder, a rod, and a sheet. Some components or apparatuses are better suited to one form factor or another. For example structures which comprise many laminar portions may be more rapidly manufactured from sheets, whilst more complex or abstract structures might be better suited to the use of powder. However, the benefits of adding a photothermal agent to the construction material can be realised irrespective of the form factor of the construction material.

Similarly, the present techniques can be applied to construction materials comprising any of a wide range of substances or materials. The presently disclosed techniques are particularly advantageous when applied to construction materials with high reflectivities and/or low absorptivities. According to some examples, the construction material may comprise metal, a polymer, ceramics and/or glass (e.g. fused silica, silica-based and other glasses).

Viewed from a third aspect, the present invention relates to a method for additive manufacturing comprising directing electromagnetic, EM, radiation onto an additive manufacturing feedstock, thereby fusing portions of the additive manufacturing feedstock to form a component. Directing EM radiation may be specific and selective, or broad so as to cover a substantial portion of the AM feedstock. As above, the AM feedstock comprises a construction material and a photothermal agent to convert at least a portion of the light into thermal energy. Furthermore, as above, the photothermal agent is in thermally conductive contact with the construction material and comprises chemically modified graphene, CMG. In some examples, the CMG comprises RGO, as mentioned with regard to the AM feedstock above.

By carrying out AM in this way, it is possible to manufacture parts with a higher relative density than comparative examples such as those not employing CMG. This allows improved component quality, even without performing pre- or post-treatments such as heat treatments as described above. Thus, viewed from one perspective, a one-step AM process is provided for a wide range of construction materials, as the photothermal agent can enhance the photothermal properties of even low absorptivity and/or high reflectivity construction materials.

In order to account for overhangs in components, comparative examples may employ support elements, which may be introduced alongside the component, for example being integrally manufactured with the component for later removal. However, with the present approach, intricate features and overhang features can be manufactured without pre- or post-heat treatment and/or with no or less reliance on support structures. This also increases the rate at which components can be manufactured, as support structures do not need to be removed, and uses less energy overall to manufacture such components. The design process for a component is also simplified as, without performing a post-treatment, no or less allowance for shrinkage or warping is required.

According to some examples, the method is carried out by an additive manufacturing apparatus. In such examples, the method comprises adding the photothermal agent to the construction material, whereby to produce the additive manufacturing feedstock. The AM apparatus may include any suitable apparatus for processing the feedstocks disclosed herein into components.

An optional implementation of such examples involves adding the photothermal agent prior to introducing the additive manufacturing feedstock into the additive manufacturing apparatus. Alternatively, the adding may be performed subsequent to introducing the construction material into the additive manufacturing apparatus. In some examples according to this latter case, said adding comprises depositing the photothermal agent onto the construction material, whereby to produce the additive manufacturing feedstock.

In one particular example, depositing comprises selectively depositing the photothermal agent, from a depositor of the additive manufacturing apparatus, onto areas of the construction material that are to be fused to form the component. The depositor may be a print head, a nozzle or the like arranged to print, spray or otherwise deposit the photothermal agent onto the construction material. For example, in the context of an LPBF system, the depositor can be a powder dispenser, dosing unit, powder hopper, etc.

According to an example, the construction material has a form factor of a powder and is layered onto a bed of the AM apparatus. A print head of the AM apparatus selectively prints a design corresponding to a cross-section of a component being manufactured. Then, an EM radiation source irradiates either the whole powder bed or only the regions that have been printed, in order to fuse the printed portions of the powder to form part of the component.

Although in this example the AM feedstock is a powder, as mentioned above, the additive manufacturing feedstock may have a form factor of one of a powder, a rod, and a sheet.

In some examples, said directing EM radiation comprises directing EM radiation from one or more of: LED light sources; a cartridge heater; a heat lamp; and a quartz-tungsten infrared heater. LED light sources are particularly energy efficient to run, thus reducing the energy consumption of the AM process as a whole.

In other examples, said directing EM radiation comprises directing EM radiation from at least one laser. A laser beam is highly concentrated and narrow, and therefore can be very specifically directed to fuse portions of the AM feedstock to form a component with an intricate design.

Said laser may optionally have a wavelength in the range of 0.18 to 10.6 micrometres or, in a refinement, the laser has a wavelength in the range of 0.8 to 1.5 micrometres. Whilst CMG advantageously improves the photothermal properties of AM feedstocks for a wide range of potential laser wavelengths, it has been demonstrated to perform consistently across the range of wavelengths from 0.8 to 1.5 micrometres. This wavelength range covers a large number of commercial laser systems and, thus, most existing AM apparatuses can benefit from the advantages of the present invention.

Viewed from a fourth aspect, the present invention relates to a photothermal agent for enhancing photothermal properties of an additive manufacturing feedstock, the photothermal agent comprising chemically modified graphene, CMG. In an optional refinement, the CMG comprises reduced graphene oxide, RGO.

Furthermore, according to some examples, the photothermal agent is provided in a dispersible medium to disperse from a print head. By providing the photothermal agent in a dispersible medium, it may be employed in additive manufacturing systems that disperse additives onto construction materials as part of the additive manufacturing process. That is, for systems that utilise a print head to deposit the photothermal agent onto areas of the construction material that are to be fused to form the component, it is advantageous to provide the photothermal agent in such a way as it is able to be specifically directed, such as in a dispersible medium.

### BRIEF DESCRIPTION OF THE DRAWINGS

One or more embodiments of the invention will now be described, by way of example only, and with reference to the following figures in which:

FIG. 1 shows a schematic cross-sectional view of an additive manufacturing feedstock, according to an example of the present invention;

FIG. 2 schematically shows an example scheme for manufacturing an additive manufacturing feedstock, according to an example of the present invention;

FIG. 3 schematically shows an example implementation of the scheme of FIG. 2;

FIG. 4 schematically shows a method of manufacturing an additive manufacturing feedstock, according to an example of the present invention;

FIG. 5 schematically shows an additive manufacturing apparatus according to an example of the present invention;

FIG. 6 schematically shows an additive manufacturing apparatus according to an example of the present invention;

FIG. 7 schematically shows a method for additive manufacturing, according to an example of the present invention;

FIG. 8 schematically shows a number of example configurations for an additive manufacturing feedstock comprising a photothermal agent and a construction material, according to an example of the present invention;

FIG. 9 shows a graphical relation between the relative density of manufactured powder melt tracks and laser scan speed, according to an example of the present invention; and

FIG. 10 shows a mechanism map showing changes in melt track morphologies during laser powder bed fusion, relative to laser scan speed, for powders with a photothermal agent comprising a carbon additive and powders with a photothermal agent comprising RGO, according to an example of the present invention.

### DETAILED DESCRIPTION

The invention is further described with reference to the following examples. It will be appreciated that the invention as claimed is not intended to be limited in any way by these examples. It will also be recognised that the invention covers not only individual embodiments but also a combination of the embodiments described herein.

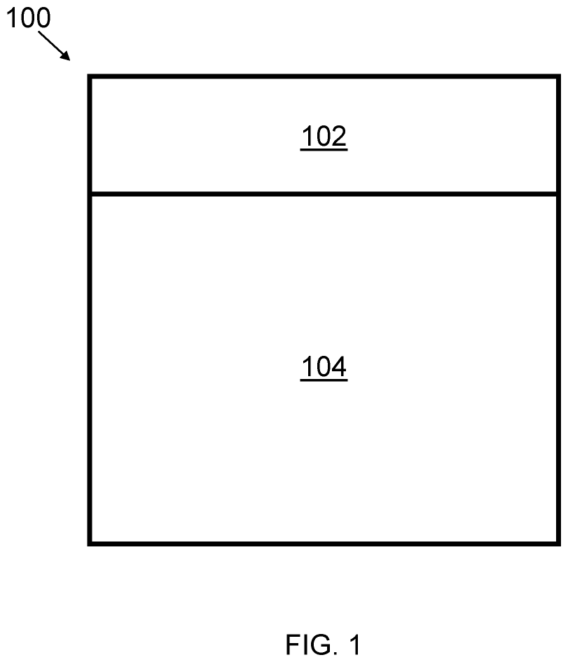

FIG. 1 shows a schematic cross-sectional view of an additive manufacturing feedstock 100, according to an example of the present invention.

As illustrated in FIG. 1, the additive manufacturing feedstock 100 ‘AM feedstock’ or simply ‘feedstock’ in the following) comprises a construction material 104 and a photothermal agent 102. The construction material 104 can have a range of form factors (e.g. a powder, sheet or rod) and can be made from a wide range of materials (e.g. metal, a polymer, glass, and/or ceramics, e.g. silica). The photothermal agent 102 converts at least a part of the light that is incident upon it into thermal energy, owing to the photothermal effect that is well understood in the material sciences. In this example, the construction material 104 does not induce as great a photothermal effect as the photothermal agent 102 when light is incident upon it. Materials with such properties include glass (which is transparent to some EM radiation) or copper (which is reflective of some EM radiation). Therefore, the overall photothermal properties of the AM feedstock 100 are enhanced by the addition of the photothermal agent 102 to the construction material 104.

The photothermal agent 102 comprises chemically modified graphene CMG. CMG has good photothermal and thermal conduction properties, which gives it high performance to use as a photothermal agent 102 for use in the presently disclosed AM techniques. One example of CMG is reduced graphene oxide (RGO).

Whilst only one homogenous unit is illustrated for ease of understanding, having one schematic block of AM feedstock 100 with abutting blocks of construction material 104 and photothermal agent 102, the arrangement may be more complex. For example, the illustrated AM feedstock 100 may represent one unit of many that collectively make up particles of a powdered feedstock that is to be manufactured into a component. Other potential arrangements are discussed below.

The photothermal agent 102 is shown abutting the construction material 104 and may be physically attached thereto, for example mechanically embedded therein. Alternatively, the photothermal agent 102 can be provided as a fine powder dispersed amongst a powdered construction material 104.

In yet another implementation, the photothermal agent 102 is added to the construction material 104 in an aqueous form, for example sprayed onto the construction material 104 or poured over the construction material 104 and allowed to dry onto the surface of the construction material 104. An advantage of using CMG in the photothermal agent 102 is that it can be tailored for a solution in water or other solvents and easily transported and/or applied to the construction material 104 in this way.

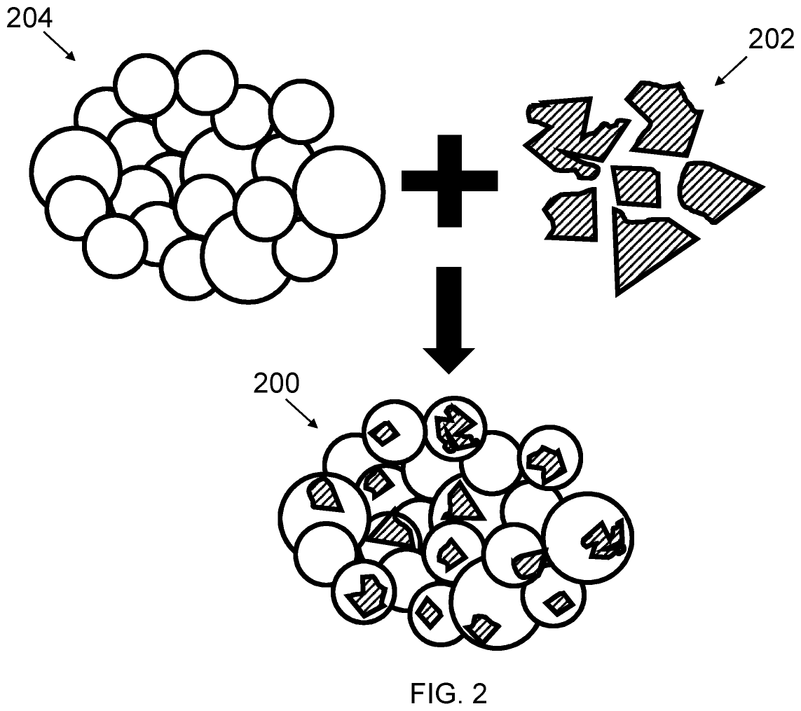

FIG. 2 schematically shows an example scheme for manufacturing an additive manufacturing feedstock 200, according to an example of the present invention.

As illustrated in FIG. 2, the example method involves adding a photothermal agent in the form of flakes 202 to a construction material in the form of a powder 204 so as to produce the AM feedstock 200. This adding process is schematically shown as a plus sign, “+”. The feedstock 200 is thus a mixture of powdered construction material 204 with flakes of photothermal agent 202.

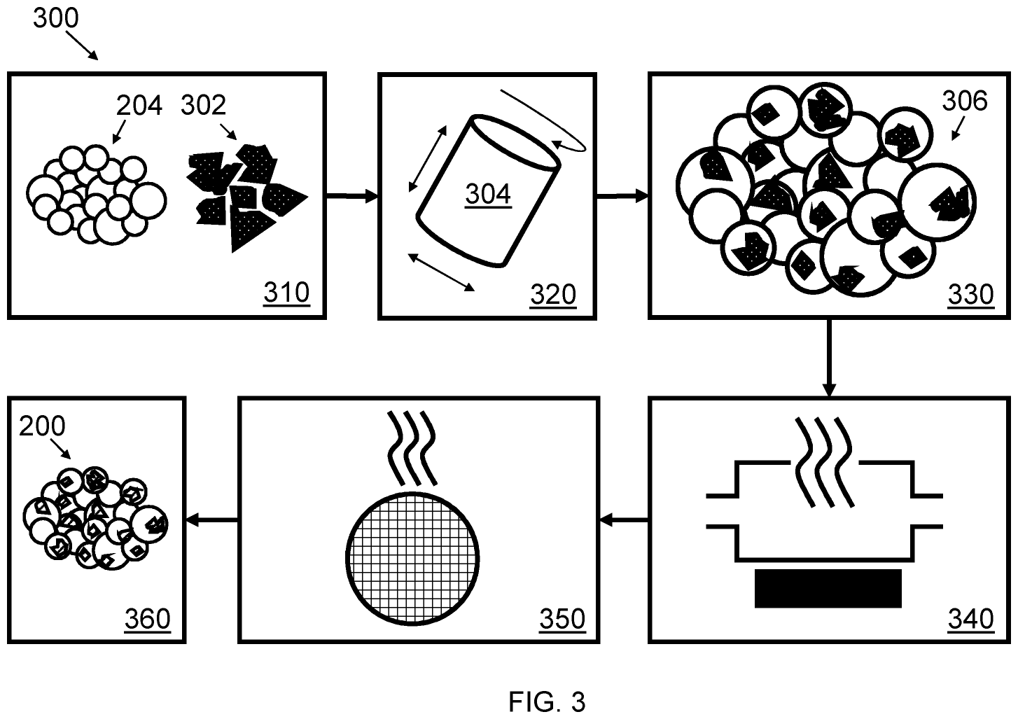

FIG. 3 schematically shows an example implementation 300 of the scheme for manufacturing an additive manufacturing feedstock from FIG. 2.

In this example implementation, instead of providing the illustrated flakes of photothermal agent 202 as in FIG. 2, flakes 302 of a chemical precursor to the photothermal agent are provided with the construction material 204 (shown in step 310). According to this example implementation, the photothermal agent is RGO and the precursor to the photothermal agent is graphene oxide (GO). In this example, the construction material 204 is powdered glass (SiO₂).

In this example, the adding process is shown in step 320 as a mechanical mixing of the powder 204 with the GO flakes 302, in a mixing vessel 304, to form a mixture 306. This technique can cause fragments of the GO flakes 302 to become embedded in the particles of the powder 204 as illustrated in step 330. Mixing can involve physically shaking/spinning the vessel 304, as illustrated in step 320, and/or mixing by application of external forces, such as ultrasound or centrifuging, carried out in wet or dry conditions.

Additional components such as water, a solvent and/or mixing media may be added during mechanical mixing in order to allow the GO flakes 302 to be dispersed evenly throughout the mixture 306. In one example, a methyl ethyl ketone (MEK) solvent is added into the mixing vessel 304 along with an alumina milling media, which together break down and distribute the GO flakes 302 throughout the mixture 306.

As illustrated in step 340 of the example implementation 300, the mixture 306 is chemically treated. According to this example, chemically treating the resulting mixture 306 comprises applying heat treatment to the mixture 306. This heat treatment can occur in the presence of a hydrogen and argon mixture, at a temperature of 950° C., for example.

Once chemically treated, the resulting mixture 306 is dried and sieved to, for example, break down any aggregates that could affect flowability of powder and thus accuracy of the print, as shown in step 350.

The final step 360 is the production of the AM feedstock 200 having a construction material (i.e., the particles of the powder 204) in thermally conductive contact with a photothermal agent (i.e., RGO). Whilst the chemical treatment step 340 comprises a thermal treatment in this example, reactive or other methods may be used to reduce the oxygen content (oxygen and other oxygen functional groups, e.g. OH, COOH, etc.) of the GO so as to produce RGO.

In this example, the resultant AM feedstock 200 comprises RGO in thermally conductive contact with the SiO₂ particles 204. As discussed above, RGO, as an example of CMG, has very good photothermal and thermal conduction properties. Thus, the proportions of RGO in the resultant feedstock 200 can be relatively small compared to the amount of SiO₂. This allows glass components, e.g. silica-based glass components, to be manufactured with a very high relative density. In some examples, this can be as high as 99.6%.

By reducing the GO 302 into RGO, advantageous chemical properties such as water solubility or affinity for binding with particular other materials etc. are achieved, which increases the ways in which the photothermal agent, comprising RGO, can be added to a construction material 204. It is possible that this reducing step can take place before adding the GO 302 to the construction material 204.

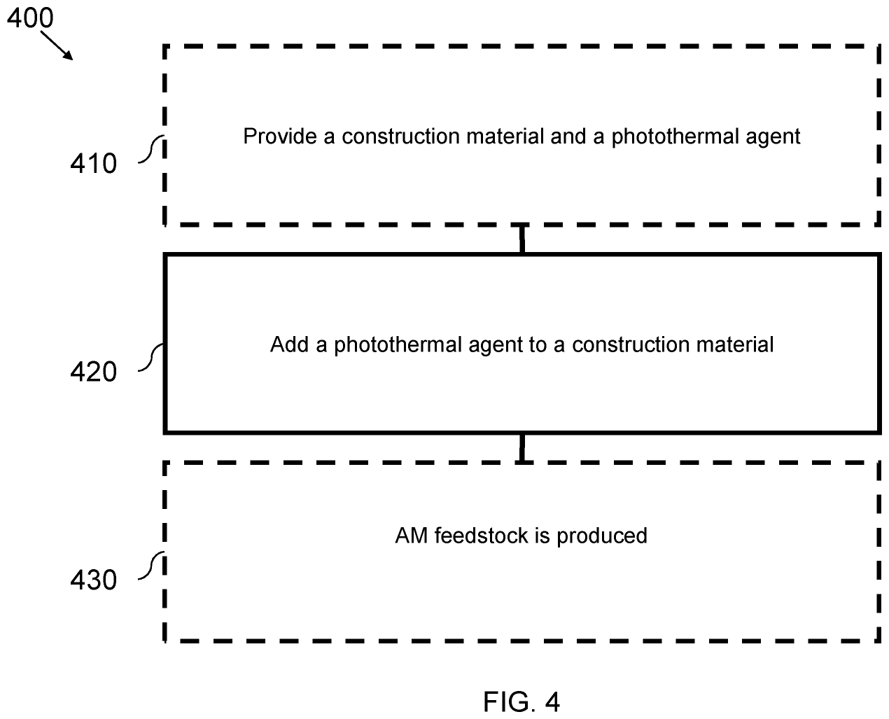

FIG. 4 schematically shows a method 400 of manufacturing an additive manufacturing feedstock, according to an example of the present invention. Method steps illustrated with dashed borders may not be carried out by the same actor as those steps illustrated with solid borders.

At step 410 of the method 400, a construction material and a photothermal agent are provided. According to this example, the photothermal agent comprises CMG.

Step 420 of the method 400 involves adding a photothermal agent to a construction material, wherein the adding causes the photothermal agent to be in thermally conductive contact with the construction material.

Finally, at step 430, and resulting from the adding 420 of the photothermal agent to the construction material, an AM feedstock is produced.

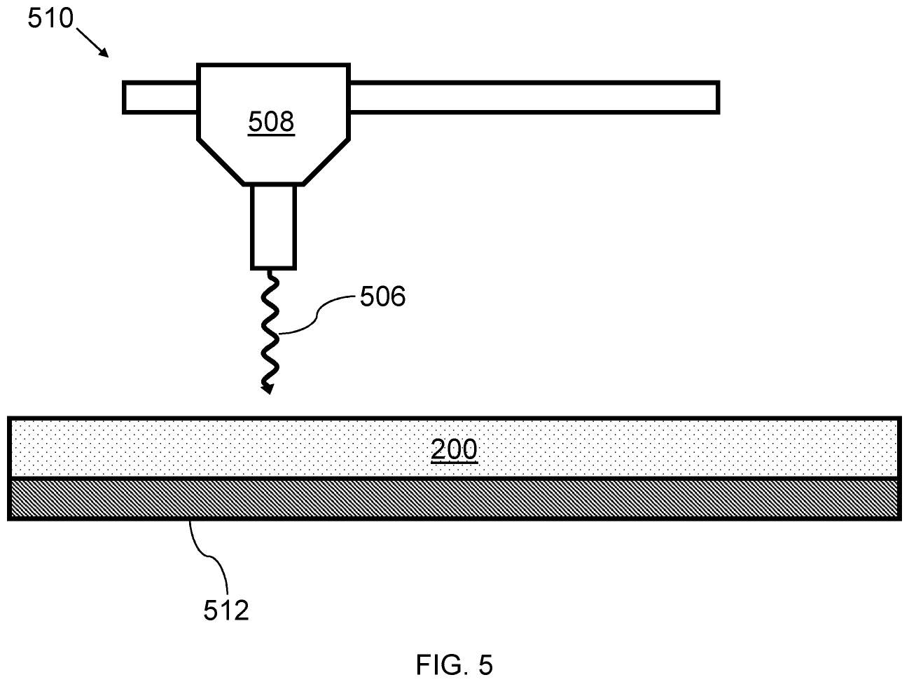

FIG. 5 schematically shows an additive manufacturing apparatus 510 according to an example of the present invention.

The AM apparatus 510 according to this example comprises a radiation source 508 (or simply ‘source 508’) that is arranged to direct EM radiation 506 toward an AM feedstock 200. The AM feedstock 200 may be an AM feedstock 200 manufactured using the method described with reference to FIG. 2.

In this example, the source 508 is a laser source and EM radiation 506 is a laser beam. Furthermore, in this example, the laser beam has a wavelength in the range of 0.18 to 10.6 micrometres.

In use, the source 508 is operated in such a way as to selectively direct the EM radiation 506 toward the feedstock 200. Irradiated portions of the feedstock 200, having a photothermal agent comprising CMG therein, heat up, melt, and thereby fuse with surrounding portions of the feedstock 200. The EM radiation 506 may be selectively directed according to an input design, which is deconstructed into a series of design layers. For each layer of the design, a layer of feedstock 200, e.g. powdered feedstock, is distributed within the AM apparatus onto a bed 512 of the AM apparatus, sufficiently to cover the entirety of the present design layer.

Portions of the feedstock 200 are then fused according to the design of the present design layer. Subsequently, another layer of the feedstock may be laid on top of the previous layer for subsequent fusing thereupon according to the design of the subsequent design layer. Excess feedstock 200 from a previous layer step may be repurposed for subsequent layers to reduce unnecessary consumption of the feedstock 200 during the AM process.

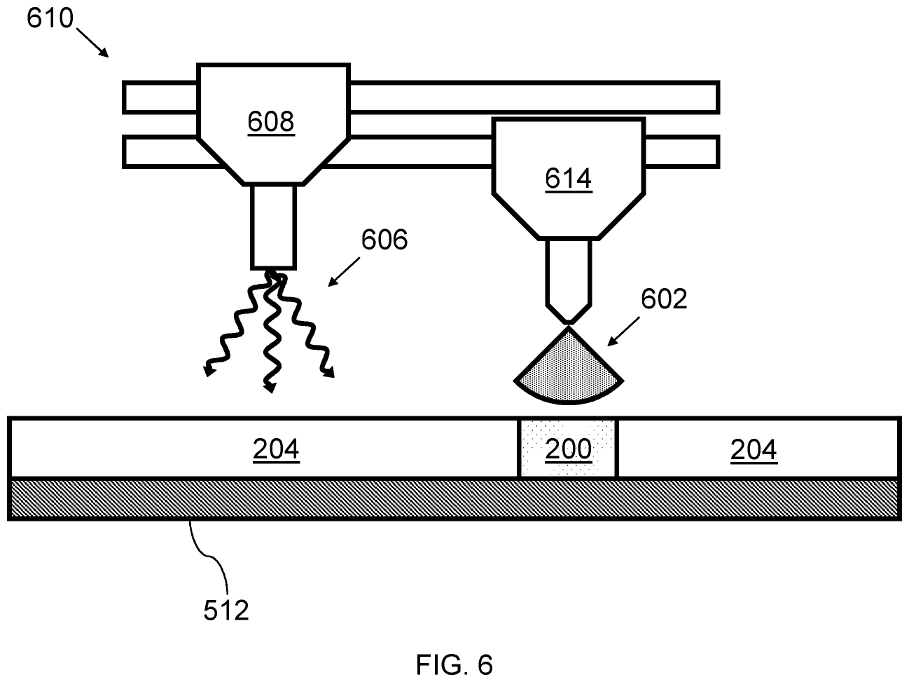

FIG. 6 schematically shows an additive manufacturing apparatus 610 according to an example of the present invention.

Similar to the AM apparatus 510 depicted in FIG. 5, the AM apparatus 610 illustrated in FIG. 6 has a bed 512 for disposing material upon. However, in this example, it is construction material (in this case powder 204 as with FIG. 2 and FIG. 3) that is disposed on the bed as opposed to pre-made feedstock.

AM apparatus 610 further comprises an EM radiation source 608 similar to EM radiation source 508, however this particular source 608 is less directional than the laser of source 508: the source 608 directs EM radiation 606 in a less specific manner. For example, the source 608 may broadly irradiate a relatively large portion of the powder bed 512.

In this example, the AM feedstock 200 is created as part of the AM process. The AM apparatus 610 comprises a print head 614 or other depositing means arranged to selectively deposit photothermal agent 602 onto the powder 204, thus creating the enhanced AM feedstock 200.

The print head 614 is arranged to deposit photothermal agent 602 onto portions of the construction material 204 corresponding to those intended for fusion into a layer of a component. The source 608 will then either irradiate the entire bed 512 or be generally directed toward the portions of AM feedstock 200. If the powdered construction material 204 has a very low absorptivity relative to the feedstock 200, irradiating the entirety of the powder bed 512 will still be able to produce high-quality components as the EM radiation 606 will not melt the powder 204 that has not been printed.

By not requiring a movable source 608, the AM apparatus 410 may advantageously comprise fewer moving parts and thus can be easier to construct, maintain, and operate. Thus, in some systems, the source 608 may be a moving source whilst in other systems the source 608 may be a stationary source. When the source 608 is a stationary source, it is desirable to arrange the source 608 so that it entirely or substantially covers the bed 512 with EM radiation 606.

Whilst source 608 and print head 614 are shown as being independent elements of the AM apparatus 610, these could also form part of the same element. For example, the print head 614 could have the source 608 mounted adjacent thereto, or co-axially, so that powder 204 printed with the photothermal agent 602 (thus forming AM feedstock 200) is irradiated shortly after deposition whilst the photothermal agent 602 is still near the surface but has been allowed time to sufficiently coat the powder 204 to produce the AM feedstock 200.

For the sake of explanation, FIG. 5 and FIG. 6 are illustrated using the example feedstock 200 from FIG. 2 and FIG. 3. However, any AM feedstock described herein could be used in its place.

Furthermore, although layer-by-layer AM processes have been referred to, the present technique is applicable to other types of AM processes. For example, the print head 614 can be arranged to extrude the AM feedstock in the form of a rod/wire. The rod can be selectively positioned and irradiated by source 608 in order to melt the rod and fuse portions thereof into a component.

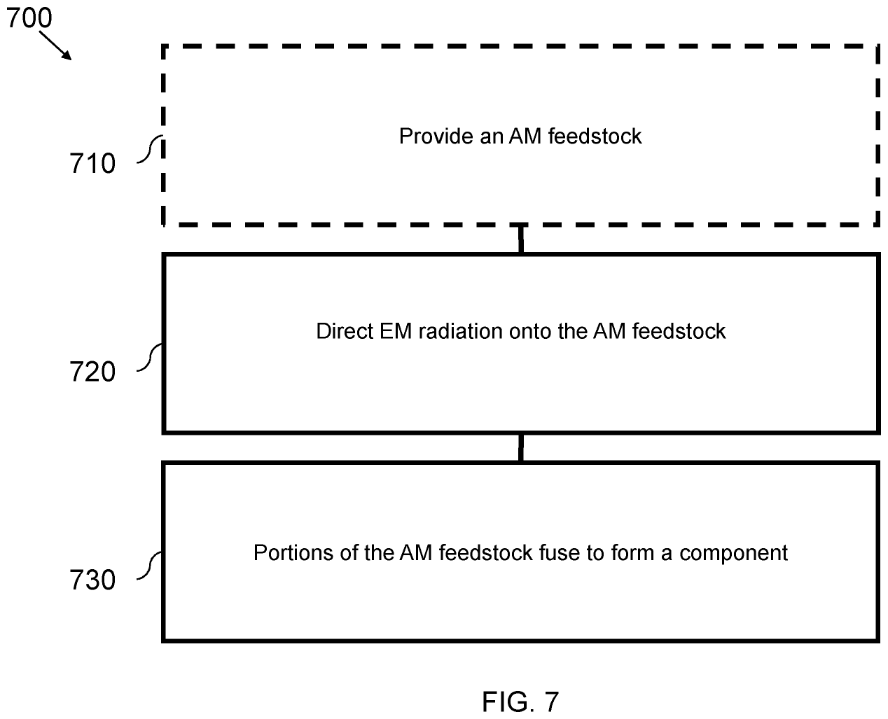

FIG. 7 schematically shows a method 700 for additive manufacturing, according to an example of the present invention.

According to this example, at step 710 an AM feedstock is provided. The AM feedstock is similar to that described previously at least in that the AM feedstock comprises a construction material and a photothermal agent to convert at least a portion of the light into thermal energy. Furthermore, as above, the photothermal agent is in thermally conductive contact with the construction material.

At step 720, the method 700 comprises directing EM radiation onto the AM feedstock. Following this, at step 730, portions of the AM feedstock are fused to form a component, in a similar manner as that described previously.

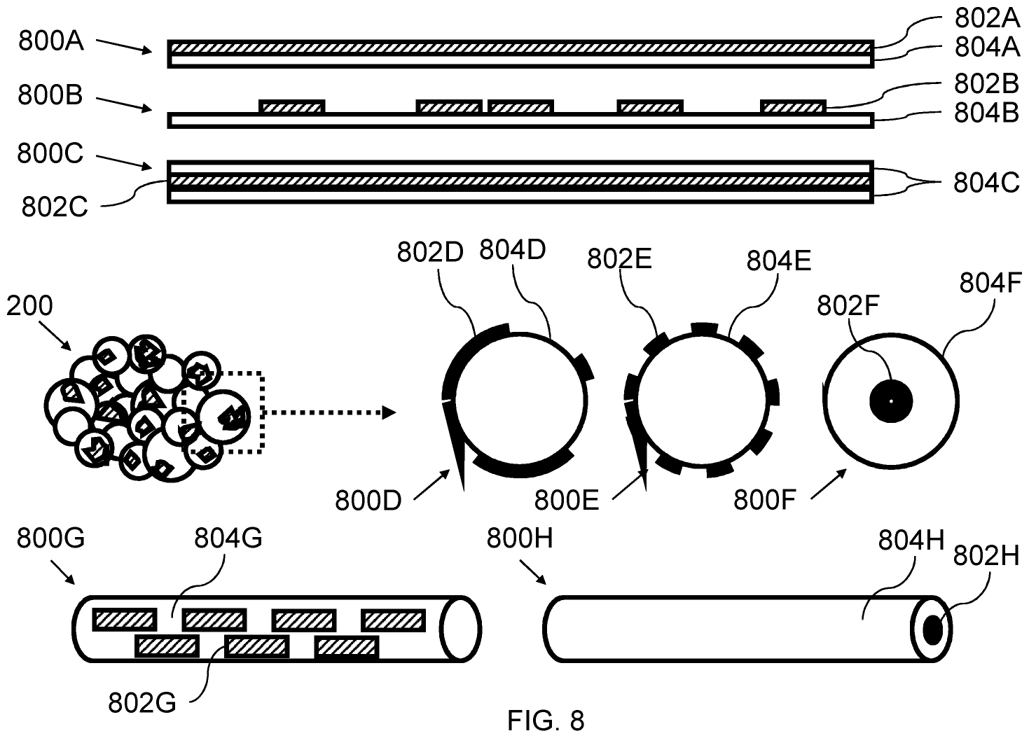

FIG. 8 shows a number of example configurations 800A-H for an additive manufacturing feedstock 800 comprising a photothermal agent 802 and a construction material 804, according to examples of the present invention.

As illustrated in FIG. 8, the additive manufacturing feedstock can have a form factor of a sheet 800A-C, a powder 200, 800D-F, or a rod 800G-H.

Configurations 800A-C are sheets shown in a cross-sectional view to schematically indicate the relative arrangements of construction material 804A-C and photothermal agent 802A-C. As shown in the example configuration 800A, the photothermal agent 802A is regularly arranged on the construction material 804A. In the example configuration 800B, the photothermal agent 802B is irregularly arranged on the construction material 804B. In the example configuration 800C, a sheet of photothermal agent 802C is disposed between sheets of construction material 804C, i.e. ‘sandwiched’ therebetween.

Configurations 800D-F are particles of a powder 200 similar to powder 200 discussed above, schematically shown in a cross-sectional view. Similar to configuration 800B, configuration 800D has photothermal agent 802D arranged irregularly around a particle of construction material 804D. As shown in example configuration 800E, the photothermal agent 802E may instead be arranged regularly arranged on an outer surface of the construction material 804E. Alternatively, as illustrated in example configuration 800F, the construction material 804F can be arranged to at least partially or entirely surround the photothermal agent 802F. In examples where the construction material 804 surrounds the photothermal agent 802, it is desirable that the construction material 804 is substantially transparent to the EM radiation being used in in the AM process. Then, the EM radiation can be incident upon the photothermal agent 802 and thereby cause the photothermal agent 802 to heat up and transfer this heat to the surrounding construction material 804.

Configurations 800G-H are rods schematically shown in perspective view. Configuration 800G shows photothermal agent 802G arranged regularly on an outer surface of the construction material 804G.

Similarly to configurations 800C and 800H, rod configuration 800H shows the photothermal agent 802H at least partially surrounded by the construction material 804H. The arrangement shown in these configurations may be particularly advantageous as they provide a maximal surface area of thermally conductive contact and, therefore, even smaller amounts of photothermal agent 802 can be used whilst still achieving the advantages discussed herein.

As mentioned above, the inclusion of CMG in a photothermal agent for addition to a construction material provides a number of advantages. To demonstrate these advantages by way of a particular example, a comparative example is considered. In the following discussion, the comparative advantages of a photothermal agent comprising RGO (taken as an example of CMG) are described relative to a photothermal agent comprising carbon black (C). Through the discussion of experimental results, the photothermal and thermal conduction superiority of CMG is made apparent.

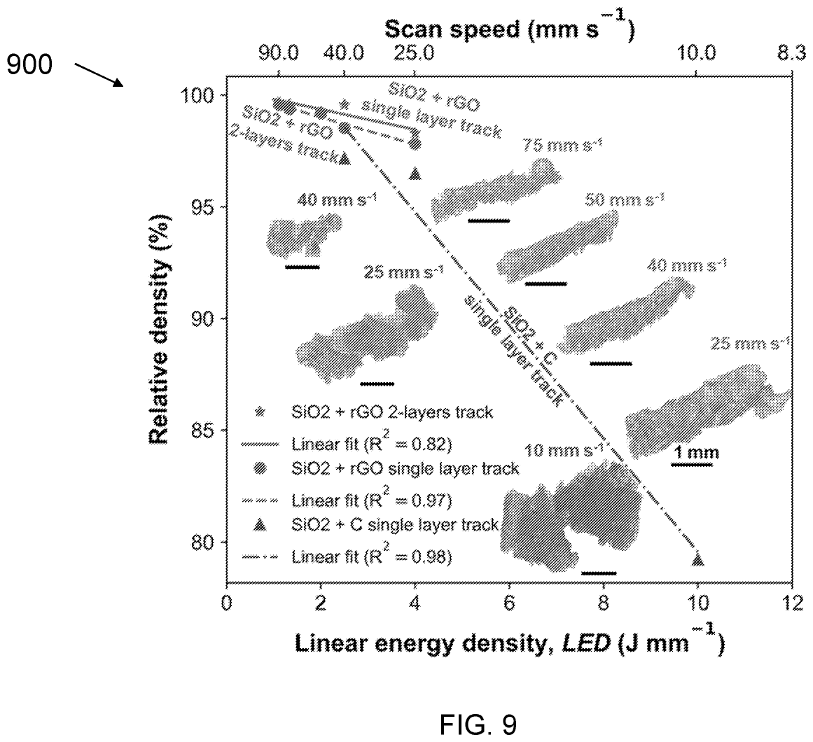

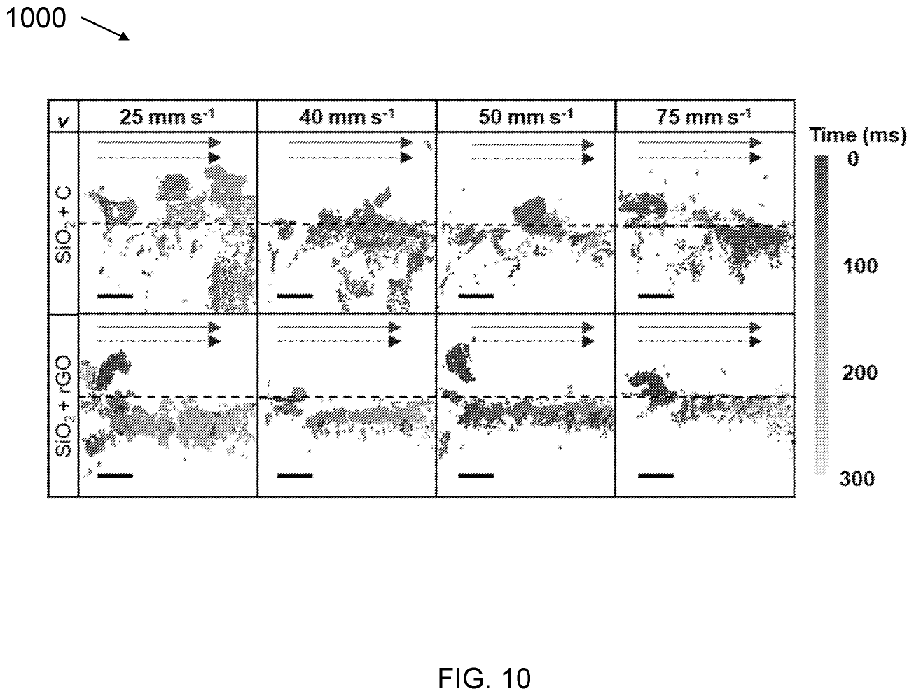

FIG. 9 and FIG. 10 show experimental results comparing the relative performance of a photothermal agent comprising CMG and a photothermal agent comprising C, in the particular context of LPBF using a near-infrared (NIR) laser source and a powdered glass (SiO₂) construction material (i.e. glass in the form of a powder). It is typically difficult to manufacture components from SiO₂ using AM techniques as it has an absorptivity of <0.05.

FIG. 9 shows a graphical relation 900 between the relative density of manufactured powder melt tracks and laser scan speed, according to an example of the present invention. ‘Powder melt tracks’ are contiguously bonded portions of a powder feedstock and ‘laser scan speed’ relates to the speed at which EM radiation from the laser is moved across the powder feedstock when forming the powder melt tracks.

Shown in the graph are the results from SiO₂+C and SiO₂+RGO, labelled accordingly. The linear energy density is calculated by dividing laser power and scan speeds. Also shown are three-dimensional image volumes generated from X-ray computed tomography scans. The scale bar for these volumes is 1 millimetre.

At fast scan speeds (or the lower input linear energy densities), this reduces vaporisation of low temperature volatiles within the powder mixtures (sometimes referred to as the ‘reboil’ effect) and minimises reaction between the photothermal agent and SiO₂. Faster scan speeds can also result in faster manufacture of a component.

For SiO₂+C, the relative density of the melt tracks varies from ca. 79.8% to 98.5%; however, the geometry of the tracks are very small compared to their expected volume due to a lack of fusion, especially for faster scan speeds. Without fusion, components cannot be reliably manufactured using this technique.

For the SiO₂+RGO, the relative density varies from 97.8% to 99.6% under the conditions studied by the present inventors. FIG. 9 shows that both C and RGO used as photothermal agents can enhance the near-infrared (NIR) absorbance of SiO₂ and enable the melting and vitrification of SiO₂ using a NIR laser system. However FIG. 9 also shows RGO demonstrates reliable generation of melt tracks—that is, melt tracks with geometry corresponding to their expected volume—with increased relative density. Therefore, RGO-comprising photothermal agents have demonstrable advantages over C-comprising photothermal agents.

FIG. 10 shows a mechanism map 1000 showing changes in melt track morphologies during LPBF, relative to laser scan speed, for SiO₂ powders with a photothermal agent comprising C and SiO₂ powders with a photothermal agent comprising RGO, according to an example of the present invention.

Each image illustrates the dynamic changes of melt pool behaviour and melt track morphologies with respect to scan velocity and powder compositions over time (see gradient scale on the right). The black dotted line indicates the powder bed surface, the solid arrows indicate the scan direction of the laser beam, and the dotted arrows indicate the flow direction of argon gas, which is introduced to mitigate reactions with the surrounding air. The solid black bars at the bottom-left of each sub-plot are scale bars representing 1 millimetre.

The plots depicted in FIG. 9 demonstrate that CMG (of which RGO is an example) is a particularly advantageous photothermal agent for AM applications. For example, the atomic arrangement of CMG, combined with a low oxygen-carbon ratio results in a smaller optional bandgap than, for example, C (0.553 eV for CMG as opposed to 0.656 eV for C) for the photothermal effect and radiation conduction to take place. Thus, whilst comparative approaches that include C as a photothermal agent in their feedstocks may be able to manufacture improperly formed melt tracks with a relative density of greater than 80%, components can be manufactured using CMG (e.g. RGO) that reliably achieve a relative density of 99.7%. This is illustrated at least in part in FIG. 9

It is shown in FIG. 10 that the melt tracks for SiO₂+C are more spatially distributed across the depth of the powder bed but also across the length of the laser beam path. That is, a number of disjointed melt tracks are shown, extending above and below the surface of the powder bed surface.

In contrast, FIG. 10 shows that melt tracks for SiO₂ exhibit good geometries, being well connected across their length and not extending far below or above the surface of the powder bed. Thus, it is clear from this comparative example that the use of CMG in a photothermal agent provides the potential to manufacture components with greater precision. Therefore, according to the present techniques, components can be rapidly manufactured out of a wide range of construction materials, the components having high relative density and also having the potential for intricate designs or overhang sections. These advantages can be provided without pre- or post-treatments. Hence, the present techniques are effectively one-step AM techniques.

As such, there is described herein a method for producing an additive manufacturing feedstock, the method comprising adding a photothermal agent to a construction material to cause the photothermal agent to be in thermally conductive contact with the construction material, whereby to produce the additive manufacturing feedstock, wherein the photothermal agent comprises chemically modified graphene, CMG.

CMG has enhanced photothermal and thermal conduction properties, having approximately 5 times better absorptivity (for NIR) and 30 times better thermal conductivity than a comparative example employing C. CMG also has advantageous chemical properties such as the ability to be made soluble or adapted to bonding with particular chemical groups. Therefore, adherence with a wide range of construction materials is made possible. As a result of the enhanced photothermal and thermal conduction properties, a wider range of construction materials can be used, including in existing commercial AM apparatuses such as those employing NIR lasers. This includes construction materials having high melting points, high reflectivity, low absorptivity, and a variety of form factors, as discussed above.

A further benefit of the use of CMG as described herein is that components manufactured using a photothermal agent comprising CMG can achieve very high relative densities compared to comparative examples where the photothermal agent does not comprise CMG. As the photothermal effect is so enhanced, it is possible to use less photothermal agent in the AM feedstock. Thus, AM-manufactured components using the present techniques will have greater density, greater purity of construction material, fewer imperfections, and thus overall better quality.

As shown above, the previously described advantages can be achieved at faster laser scan speeds than comparative examples. In addition, components manufactured using the present techniques require less or no post-treatment. Therefore, the throughput of component manufacturing using the presently described AM techniques can be greatly enhanced.

Any suggestion of prior art is not to be considered an admission that such prior art is widely known or forms part of the common general knowledge in the field. As used in this specification, the words “comprises”, “comprising”, and similar words, are not to be interpreted in an exclusive or exhaustive sense. In other words, they are intended to mean “including, but not limited to”.

While the invention is susceptible to various modifications and alternative forms, specific embodiments are shown by way of example in the drawings and are herein described in detail. It should be understood however that the drawings and detailed description attached hereto are not intended to limit the invention to the particular form disclosed but rather the intention is to cover all modifications, equivalents and alternatives falling within the scope of the appended claims.

1. A method for producing an additive manufacturing feedstock, the method comprising:
adding a photothermal agent to a construction material to cause the photothermal agent to be in thermally conductive contact with the construction material, whereby to produce the additive manufacturing feedstock, wherein the photothermal agent comprises chemically modified graphene, CMG.

2. The method of claim 1, wherein the CMG comprises reduced graphene oxide, RGO.

3. The method of claim 1, further comprising mechanically mixing the construction material with the photothermal agent, wherein mechanically mixing comprises an application of external force.

4. The method of claim 1, wherein adding the photothermal agent to the construction material comprises:
adding a chemical precursor of the CMG to the construction material, so as to create a mixture; and
chemically treating the mixture, whereby to produce the additive manufacturing feedstock.

5. The method of claim 4, wherein the CMG comprises reduced graphene oxide, RGO, and the chemical precursor of the CMG comprises graphene oxide, GO.

6. The method of claim 5, wherein:
chemically treating the mixture comprises heating the mixture to chemically reduce the GO to RGO.

7. An additive manufacturing feedstock, the feedstock comprising:
a construction material; and
a photothermal agent to convert at least a part of incident light into thermal energy, the photothermal agent being in thermally conductive contact with the construction material, wherein the photothermal agent comprises chemically modified graphene, CMG.

8. The additive manufacturing feedstock of claim 7, wherein:
the CMG comprises reduced graphene oxide, RGO.

9. The additive manufacturing feedstock of claim 7, wherein the additive manufacturing feedstock has a form factor of one of a powder, a rod, and a sheet.

10. The additive manufacturing feedstock of claim 7, wherein the construction material comprises at least one of:
metal,
a polymer,
glass, and
ceramic.

11. A method for additive manufacturing comprising:
directing electromagnetic, EM, radiation onto an additive manufacturing feedstock, thereby fusing portions of the additive manufacturing feedstock to form a component, wherein:
the additive manufacturing feedstock comprises a construction material and a photothermal agent to convert at least a portion of the light into thermal energy, the photothermal agent being in thermally conductive contact with the construction material; and
the photothermal agent comprises chemically modified graphene, CMG.

12. The method of claim 11, wherein:
the CMG comprises reduced graphene oxide, RGO.

13. The method of claim 11, wherein:
the method is carried out by an additive manufacturing apparatus, and
the method comprises adding the photothermal agent to the construction material, whereby to produce the additive manufacturing feedstock.

14. The method of claim 13, comprising performing said adding prior to introducing the additive manufacturing feedstock into the additive manufacturing apparatus.

15. The method of claim 13, comprising performing said adding subsequent to introducing the construction material into the additive manufacturing apparatus.

16. The method of claim 13, wherein said adding comprises depositing the photothermal agent onto the construction material, whereby to produce the additive manufacturing feedstock.

17. The method of claim 16, wherein said depositing comprises selectively depositing the photothermal agent, from a depositor of the additive manufacturing apparatus, onto areas of the construction material that are to be fused to form the component.

18. The method of claim 17, wherein said directing EM radiation comprises directing EM radiation from one or more of:
LED light sources;
a cartridge heater;
a heat lamp; and
a quartz-tungsten infrared heater.

19. The method of claim 11, wherein said directing EM radiation comprises directing EM radiation from at least one laser.

20. The method of claim 19, wherein the at least one laser has a wavelength in the range of 0.18 to 10.6 micrometres.

21. The method of claim 20, wherein the at least one laser has a wavelength in the range of 0.8 to 1.5 micrometres.

22. The method of claim 11, wherein the additive manufacturing feedstock has a form factor of one of a powder, a rod, and a sheet.

23. A photothermal agent for enhancing photothermal properties of an additive manufacturing feedstock, the photothermal agent comprising chemically modified graphene, CMG.

24. The photothermal agent of claim 23, wherein:
the CMG comprises reduced graphene oxide, RGO.

25. The photothermal agent of claim 23, wherein the photothermal agent is provided in a dispersible medium to disperse from a print head.
